(19) United States
(12) Patent Application Publication
(10) Pub. No.: US 2016/0348778 A1
(43) Pub. Date: Dec. 1, 2016

(54) DUAL-INPUT GEARBOX WITH INPUT SHAFTS COUPLED VIA A CLUTCH

(71) Applicant: Riekor Corporation, Eden Prairie, MN (US)

(72) Inventors: Timothy A. Erhart, Chanhassen, MN (US); Jeffrey Eugene O'Rourke, Saint Paul, MN (US)

(21) Appl. No.: 14/724,140

(22) Filed: May 28, 2015

(51) Int. Cl. F16H 37/06; F16H 19/02

(52) U.S. Cl. CPC F16H 37/065; F16H 19/02

(57) ABSTRACT

A gearbox includes a planetary gearset and a first input shaft coupled to a sun gear of the planetary gearset. A second input shaft is coupled to a ring gear of the planetary gearset, and an output shaft is coupled to planet gears of the planetary gearset via a carrier. The gearbox further includes a second coupling path between the first input shaft and the second input shaft that is separate from the planetary gearset. The second coupling path includes a clutch that engages and disengages in response to a speed differential between the first input shaft and the second input shaft

### SUMMARY

The present disclosure is directed to a dual-input gearbox with input shafts coupled via a clutch. In one embodiment, a gearbox includes a planetary gearset and a first input shaft coupled to a sun gear of the planetary gearset. A second input shaft is coupled to the ring gear of the planetary gearset, and an output shaft is coupled to planet gears of the planetary gearset via a carrier. The gearbox further includes a second coupling path between the first input shaft and the second input shaft that is separate from the planetary gearset. The second coupling path includes a clutch (e.g., an override clutch) that engages and disengages in response to a speed differential between the first input shaft and the second input shaft.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is perspective view of a dual-input gearbox according to an example embodiment;

FIG. 2 is a cross-sectional view of the gearbox shown in FIG. 1;

FIG. 3 is a simplified diagram of a gearbox according to an example embodiment;

FIGS. 4 and 5 are force diagrams illustrating back driving of the sun gear in a gear box according to an example embodiment;

FIGS. 6 and 7 are simplified diagrams illustrating the operation of an override clutch in a gearbox according to an example embodiment;

FIG. 8 is a flowchart of a method according to an example embodiment;

FIG. 9 is a side view of an actuator according to an example embodiment;

FIG. 10 is a perspective view of a gearbox according to another example embodiment; and

FIG. 11 is a perspective view of an actuator according to an example embodiment.

### DETAILED DESCRIPTION

The present disclosure generally relates to gearboxes utilizing planetary gearsets. A planetary gearset includes a sun gear located centrally within a ring gear. A set of planet gears couples the ring gear to the sun gear, and a carrier fixes the axes of the planet gears with respect to one another and attaches to the output shaft. By fixing one of the carrier, the sun gear, and the ring gear, a gear ratio is set for the other two, and this gear ratio is different depending on which member is fixed. In other configurations, all three rotational members can rotate.

In embodiments described herein, a dual-input gearbox has two input shafts to which separate driving elements (e.g., first and second motors) can apply rotation. One or both of the input shafts can be used to drive a single output shaft of the gearbox. This can allow the device to operate in different modes. For example, one mode may be defined where one input shaft is driven while the other input shaft is not driven, or vice versa. In other modes, both input shafts may be driven at the same time.

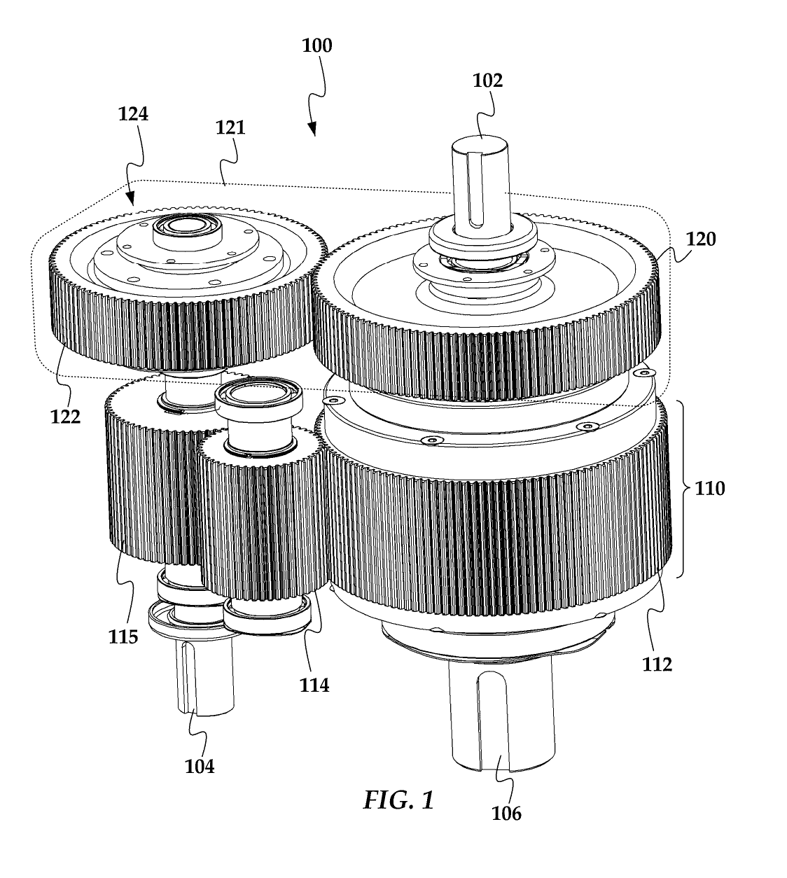

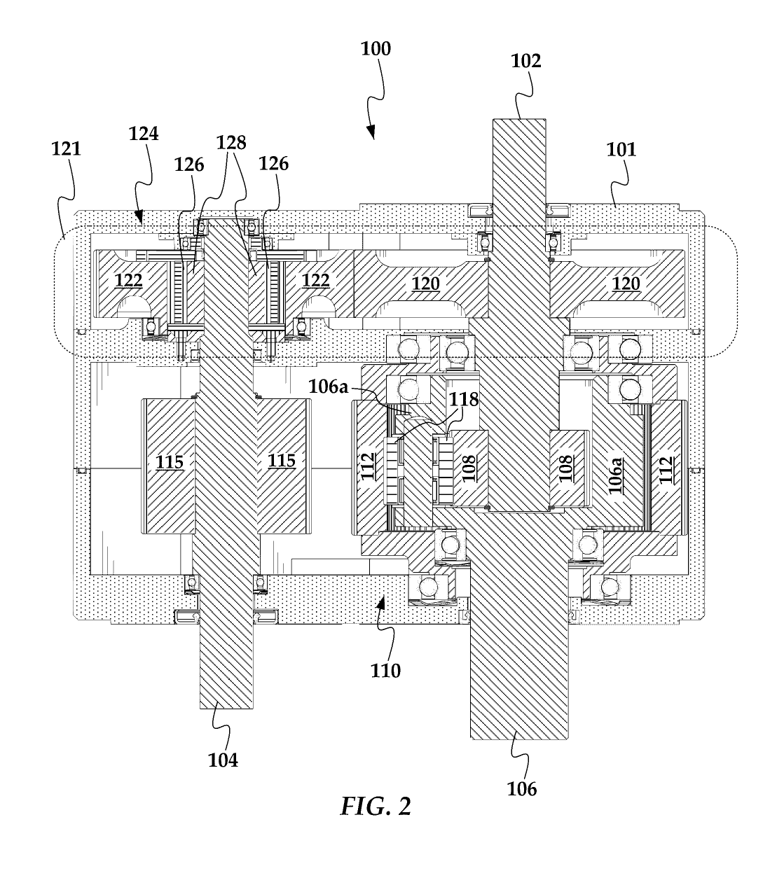

A dual-input, reduction gearbox 100 according to an example embodiment is shown in the perspective view of FIG. 1 and in the cross-sectional view of FIG. 2. In FIG. 1, the gearbox 100 is shown without housing 101, which can be seen in FIG. 2. The cross section plane of FIG. 2 is taken through the centerlines of the shafts 102, 104, 106. The gearbox 100 is configured as a reducing gearbox, e.g., one that produces lower rotation speed at the output shaft than the speed of at least one (or in this case both) of the input shafts. The gear reduction results in lower speed but with increased torque at the output compared to the input.

The gearbox 100 includes first and second input shafts 102, 104 and an output shaft 106. The first input shaft 102 may also be referred to as a primary shaft due to its alignment with the output shaft 106 and connection through what is generally considered a stronger set of gears. In the illustrated configuration, the reduction ratio to the output shaft for the first and second input shafts 102, 104 is different. As a result, if each of the input shafts 102, 104 were driven by an equivalent motor, the output shaft 106 may move relatively faster with lower torque capability in the mode where the first (e.g., primary) input shaft 102 is driven. In the mode where the second input shaft 104 is driven, the output shaft 106 may move relatively slower with higher torque capability.

The dual-input gearbox 100 may be used in applications such as presses, where a mold, form, cutter, or other tool is moved away from and towards a work piece at relatively high speed requiring only minor force/torque in one mode, and also applies a high force/torque at significantly lower speed when positioned at or near the work piece in another mode. Other applications (e.g., opening/closing of doors, movement of flight surfaces, robotics) may also take advantage of a combination of high speed—low force/torque over one part of the travel and low speed high force/torque over another part of the travel. In other cases, such as hybrid vehicles, the different inputs may be driven by different motive devices, such as electric and gasoline motors. In such a case, both inputs may be driven at the same time. The concepts described herein may be used for those applications as well.

The first input shaft 102 is affixed to a sun gear 108 (see FIG. 2) of a planetary gearset 110. The second input shaft 104 is affixed to a spur gear 115. The spur gear 115 is coupled to a ring gear 112 of the planetary gearset 110 via idler gear 114 which meshes between outer teeth of the ring gear 112 and the spur gear 115. As seen in FIG. 2, the output shaft 106 is affixed to carrier 106a via planet gears 118, the planet gears 118 meshing with inner teeth of the ring gear 112. In this example, three planet gears 118 are shown, only one of which can be seen in the cross-section. It will be understood that a different number of planet gears may be used. Note that in this embodiment, the carrier 106a is integral to the output shaft 106, e.g., machined as a single piece.

The illustrated gearbox includes a secondary coupling 121 between the first and second input shafts to prevent back-driving of the first input shaft 102 when high torque is applied to the second input shaft 104. The coupling 121 is “secondary” in that it is a second mechanical coupling path between the input shafts 102, 104, the planetary gearset 110 being the first coupling path. The secondary coupling 121 includes a spur gear 120 which is affixed to the first input shaft 102. Spur gear 120 meshes with outer gear 122, which is part of a bi-directional, override clutch assembly 124. The second input shaft 104 is coupled to the outer gear 122 if the outer gear 122 is rotating slower than the second input shaft 104, which causes the override clutch 124 to engage. As seen in FIG. 2, the bi-directional override clutch 124 includes rollers 126 and a carrier 128 that selectably engages or disengage the second input shaft 104 with the outer gear 122 based on relative rotation speeds of the second input shaft and the outer gear 122, the speed of the latter being proportional to the speed of the first input shaft 102.

In order to understand the operation of the secondary coupling 121 in regards to back-driving, the operation of the gearbox 100 is discussed in more detail. As noted above, the first input shaft 102 is commonly driven by a first motor (or other driving means) that moves the output shaft 106 at relatively high rotational speed with relatively lower torque. Stated differently, the reduction gear ratio between the first input shaft 102 and the output shaft 106 in this arrangement is relatively low compared to the second input shaft (e.g., 3:1). In contrast, the second input shaft 104 is driven by a second motor (or other driving means) that moves the output shaft 106 relatively slowly with relatively higher torque. Stated differently, the reduction gear ratio between the second input shaft 104 and the output shaft 106 is relatively high (e.g., 10:1). The first and second motors in this arrangement may be the same or similar, with the gearbox 100 providing the relative mechanical advantages via the first and second input shafts 102, 104. In other embodiments, the first and second motors may be different such that the difference in output torque and speed when the different shafts 102, 104 are driven may also be due to the different motor characteristics in addition to the gear ratios of the gear box.

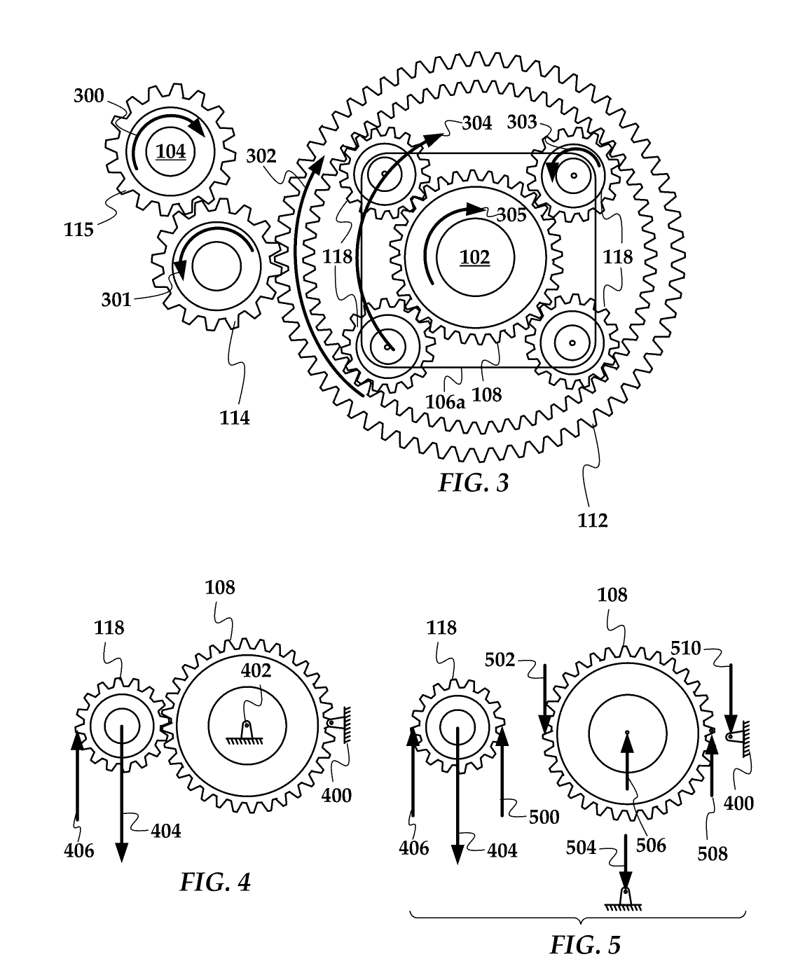

Through the use of the planetary gearset 110, both input shafts 102, 104 can be turned at the same time, or at different times. An example of this is shown in the simplified diagram of FIG. 3. It will be understood that the shafts input shafts 102, 10 can be turned in either direction, but for the example of FIG. 3, both input shafts 102, 104 are shown turning in the same direction in the different modes. In a first mode, the second input shaft 104 is fixed, and the first input shaft 102 drives the sun gear 108 as indicated by arrow 305. The rotation of the sun gear 108 causes each of the planet gears 118 to rotate as indicated by arrow 303. The planet gears 118 are tied together by the carrier 106a to the output shaft (not shown), and so the centers of gears 118 and the output shaft move collectively as indicated by arrow 304.

In a second mode, the second input shaft 104 drives gear 115 in the direction indicated by arrow 300 while the first input shaft 102 is fixed. Rotation of the second input shaft 104 causes the idler gear 114 (which is optional) and ring gear 112 to rotate as indicated by arrows 301 and 302, respectively. The rotation 302 of the ring gear 112 causes each of the planet gears 118 to rotate in the opposite direction than what is indicated by arrow 303, although the carrier 106a and output shaft will still move as indicated by arrow 304. The rotation 304 of the carrier 106a will occur if the sun gear 108 is fixed, but may also occur when the sun gear 108 is driven by the first input shaft 102 in direction indicated by arrow 305.

While in this second mode, the first shaft 102 may be held in place, e.g., by a braking motor, external brake, servo motor that is commanded to hold position, etc. Driving the second shaft 104 in direction 300 will apply a torque on the first shaft 102 in the opposite of direction 305 as shown in FIG. 3, which can result in back driving of the first shaft 102. To illustrate this, static force diagrams in FIGS. 4 and 5 show an example of moments that are applied to the sun gear 108 and the first shaft 102 in the second mode.

FIG. 4 shows the sun gear 108 pinned at anchor point 400 and supported but rotatable around center anchor point 402. Anchor point 400 represents a moment about the center anchor point 402 that the first motor of the first shaft 102 would have to overcome to maintain static equilibrium, e.g., related to the holding capability of the first motor. A single planet gear 118 is shown meshed to the sun gear 108. Force 404 represents a moment applied to the carrier due to a load at the output shaft. The sun gear 108, the carrier, and the output shaft all rotate around an axis defined by the anchor point 402, although for this analysis the anchor point 402 is assumed to only limit translation of the sun gear 402. Force 406 represents a driving force applied by the ring gear, which is driven by the second input shaft.

In FIG. 5, each of the components is shown separated with sum of forces applied to each component. Force 500 on the planet gear 118 is applied by the sun gear 108, and an equal and opposite force 502 is applied to the sun gear 108. Similarly, forces 504, 506 are equal and opposite forces applied to the center anchor point 402 and center of sun gear 108, respectively. Forces 508, 510 are equal and opposite forces applied to the anchor point 400 and sun gear 108.

As should be apparent from this simplified diagram, a moment applied by the secondary shaft 104 rotating in direction 300 as shown in FIG. 3 will impart a moment that is counter to direction 305 of the sun gear 108, as represented by forces 502 and 508 in FIG. 5. When the load on the output shaft is low, the force 404 in FIG. 5 is low, and so the moment applied to the sun gear 108 is low such that the first shaft motor may have sufficient holding capability to keep the sun gear 108 from rotating. However, once the load force 404 increases sufficiently, the first drive motor can no longer hold position, and will be back driven by the second shaft motor unless provisions are made to prevent it. In this example, back driving of the first input shaft 102 by the second input shaft 104 may occur due to the greater mechanical advantage of the second input shaft 104 compared to the first input shaft 102. In other applications, back driving may occur due to other factors instead of or in addition to gear ratios, such as low holding capacity of motors driving one of the shafts.

To prevent back driving the first input shaft 102, the secondary coupling 121 engages a direct gear coupling between the first and second shafts 102, 104 once the first shaft 102 slows down relative to the second shaft 104 (or if the second shaft 104 speeds up relative to the first shaft). In the modes described above, this will occur when the second input shaft 104 is driven and the first input shaft 102 is slowed or stopped. In such a case, the second shaft 104 will be rotating faster than the first shaft 102, which causes the override clutch 124 to engage. After engagement of the override clutch 124, the first and second shafts 102 will be directly coupled via gears 120 and 122, causing second input shaft 104 to drive both the ring gear 112 and the sun gear 108 together. This will also cause the first input shaft 102 to turn in direction 305 shown in FIG. 3. As a result, a motor (or other driving means) coupled to the first input shaft 102 may be disengaged or otherwise allowed to freely rotate before or during engagement of the override clutch 124.

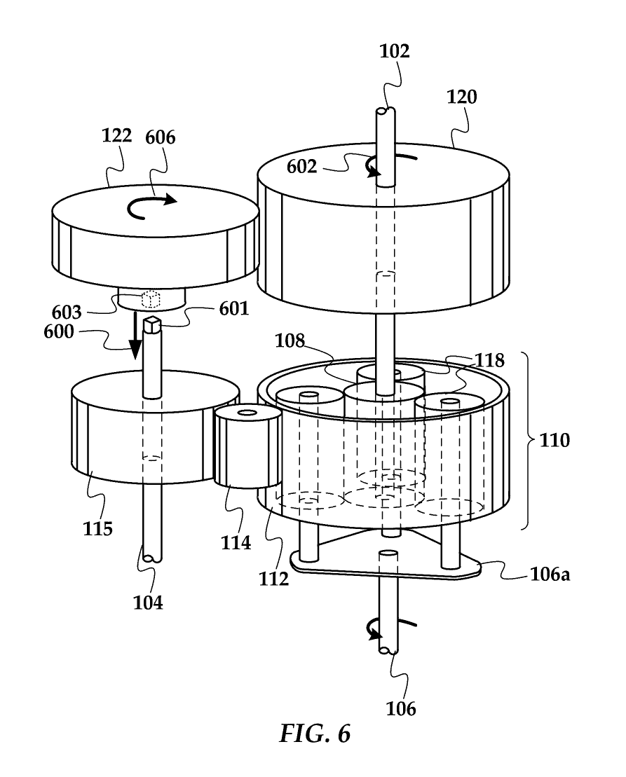

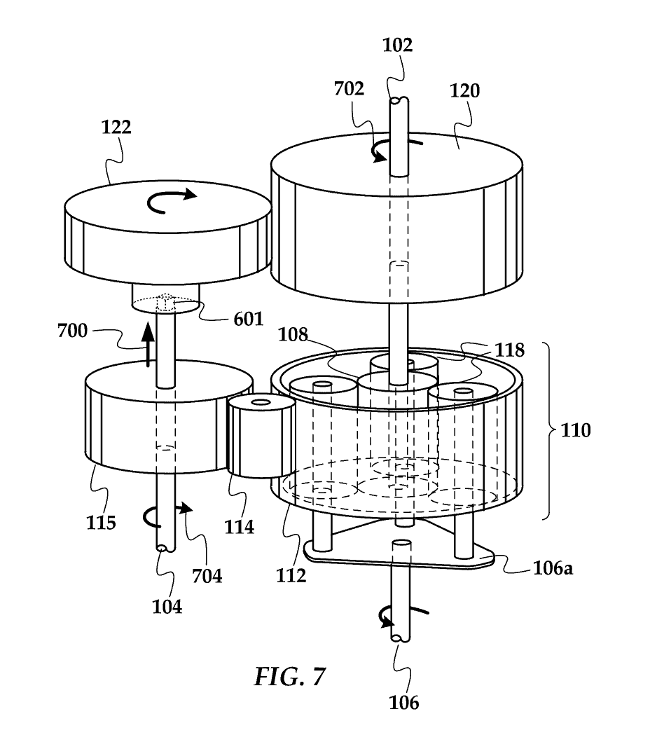

In FIGS. 6 and 7, a simplified diagram illustrates two modes the gearbox may be operating in due to disengagement and engagement of a clutch in the secondary coupling path. For purposes of convenience, FIGS. 6 and 7 use like reference numbers to identify analogous components previously shown in FIGS. 1 and 2, although the overall configurations are different. These diagrams schematically represent a clutch as a shaft end 601 that can be engaged with a matching slot 603 in gear 122. This arrangement, referred to as a “dog clutch,” is used for ease of illustration, and is intended to generally represent any clutch, including the previously described override clutch 124. The secondary coupling path may use a clutch that can be selectably engaged (e.g., mechanically or via a controller) when there is a speed differential between the first and second input shafts 102, 104. Such alternate clutches may include a plate clutch, centrifugal clutch, hydraulic clutch, electromagnetic clutch, etc. Where such clutch is externally engaged and disengaged (e.g., via a controller), sensors may be used to detect a speed differential between the first and second input shafts 102, 104. One advantage of the override clutch 124 is that is purely mechanical, and engages independently of a controller.

As represented by arrow 602, the first shaft 102 is driven and rotating with the clutch 601 is disengaged. In this figure, disengagement of the clutch is represented as lowering of shaft end 601 from gear 122 as indicated by arrow 600 so that it does not interface with the slot 603. An analogous disengagement occurs in the override clutch 124 of FIG. 2 when gear 122 (which is being driven by the input shaft 102) is rotating faster than the second shaft 106. If the gear ratio of gears 120 and 122 is 1:1, then this will directly correlate to the first shaft 102 and its associated motor rotating slower than the second shaft 104 and it associated motor. Different gear ratios between gears 120 and 122 may be used to account for variables such as different motor speeds, speed difference needed to engage the clutch, time needed to engage the clutch, etc.

In FIG. 7, the shaft end 601 is extended to engage with a matching slot in gear 122 as indicated by arrow 700, which represents engagement of the clutch. This engagement is due to slowing of the first input shaft 102 relative to the second input shaft 104. In engaged configuration, the first and second input shafts 102, 104 are coupled to each other via both the planetary gearset 110 and the gears 120, 122. This will at least prevent back-driving the first input shaft 102 by the second input shaft 104. While arrow 702 indicates the first input shaft 102 is rotating, this is being driven by the second input shaft 104, and a motor or other driving means connected to the first shaft may be allowed to spin freely or disengage. In other embodiments, e.g., where the first input shaft 102 is driven by a variable speed motor, the first input shaft 102 may also be driven in the same direction while the second shaft 104 is being driven.

The use of a clutch may provide advantages over other means that may be used to prevent this back-driving, such as a brake applied to shaft 102. For example, a clutch may be configured to take less space, resulting in a more compact gearbox. Using an override clutch provides other advantages, such as not requiring any external power or controls to selectively engage and disengage the secondary coupling path.

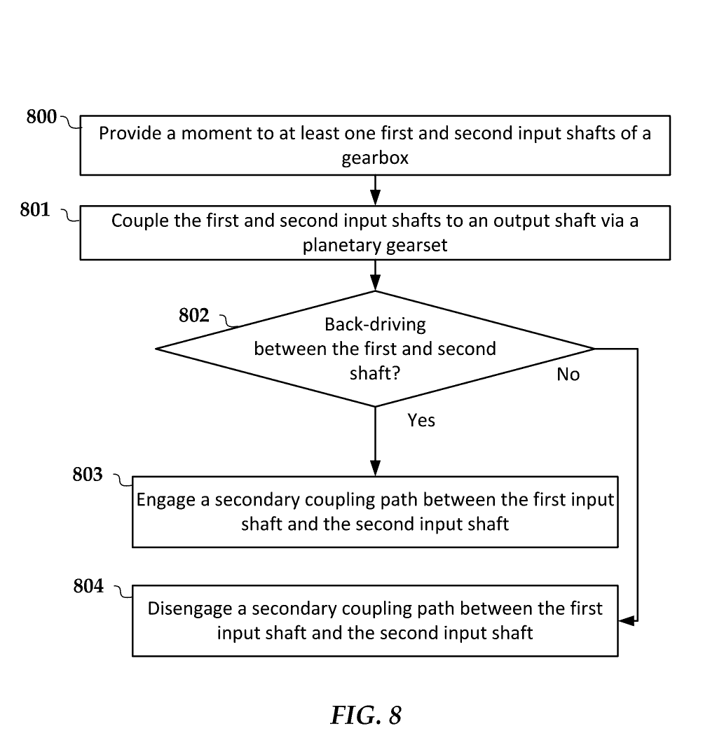

In FIG. 8, a flowchart illustrates a method according to an example embodiment. The method involves providing 800 a moment to at least one of a first and second input shaft of a gearbox. The first and second input shafts are coupled 801 to an output shaft of the gearbox via a planetary gearset. As indicated by block 802, a secondary coupling path between the first input shaft and the second input shaft is engaged 803 if there is back driving between the input shafts, or if a condition indicates is about to occur. For example, a speed differential between input shafts may indicate back driving is occurring or is about to occur. The secondary coupling path is separate from the planetary gearset. If there is no back driving between the input shafts (e.g., indicators such as shaft speeds shows back driving will not occur), then the secondary coupling path between the first input shaft and the second input shaft is disengaged 804.

In the example illustrated in FIGS. 1-7, the planetary gearset provides a reduction ratio between the first shaft 102 and the output shaft 106 that is lower than a reduction ratio between the second shaft 104 and the output shaft 106. Put another way, the planetary gearset provides a first reduction ratio of N:1 between the first input shaft and the output shaft and a second reduction ratio of M:1 between the second input shaft and the output shaft, wherein M>N. Further, the gear ratio of the secondary path (e.g., the ratio between gears 120 and 122) may be approximately a 1:1 ratio in cases where motors driving the first and second input shafts 102, 104 run at approximately the same speed and an override clutch is used. For example, the gear ratio of gears 122 and 120 may be N1:N2 where N1≈N2 (e.g., within 50 percent of each other). For example, N1:N2 may be 1:1, 1:0.7, 1:0.5, 0.7:1, 0.5:1, etc. Where motors driving the first and second input shafts 102, 104 run at significantly different speeds and an override clutch is used, then the ratio N1:N2 can be adjusted appropriately.

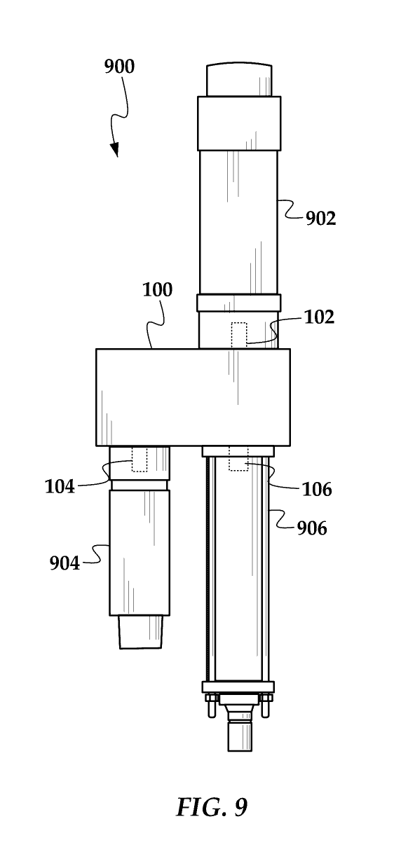

As noted above, the illustrated gearbox 100 may be used in any dual-input, single output power transmission application that utilizes rotating input and output shafts. One example applications involves driving a linear actuator. In FIG. 9, a side view shows the gearbox 100 incorporated into a linear actuator 900. First and second motors (e.g., electric servo motors) 902, 904 are coupled to the respective first and second input shafts 102, 104 of the gearbox 100. A linear drive member 906 is coupled to the output shaft 106 of the gearbox 100. The linear drive member 906 may include a screw drive or other linear actuation means (e.g., rack and pinion) that extends a rod or other actuation member in a linear direction in response to a rotational input. Other driving means besides the servo motors 902, 904 may be used, such as hydraulic motors, pneumatic motors, stepper motors, DC motors, AC motors, engines, hand cranks, etc.

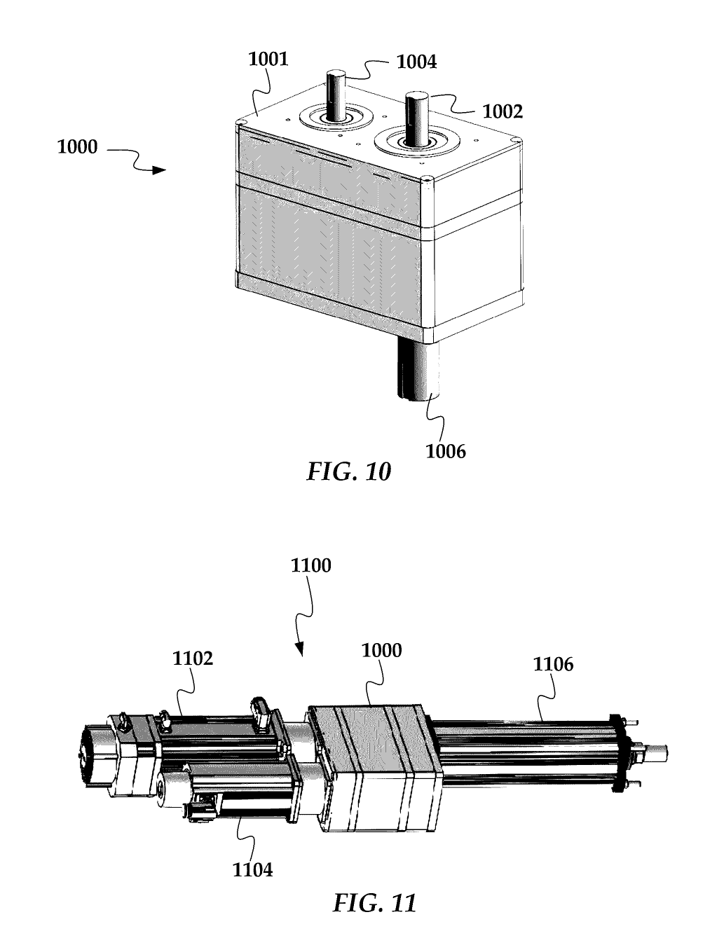

While the previous gearbox example show the input shafts on opposite sides of the gearbox housing, other variations are possible. For example, in FIG. 10 a perspective view shows a gearbox 1000 according to another example embodiment. The gearbox includes first and second input shafts 1002, 1004 and an output shaft 1006. In this example, both input shafts 1002, 1004 are located on the same side of a housing 1001 and opposite the output shaft 1006. Internally the gearbox 1000 is configured as previously described, including a planetary gearset with a sun gear coupled to the first input shaft 1002, a ring gear coupled to the second input shaft 1004, and planet gears coupled to the output shaft 1006 via a carrier. The gearbox 1000 includes a second coupling path between the first input shaft 1002 and the second input shaft 1004 that is separate from the planetary gearset. The second coupling path includes a clutch that engages and disengages in response to a speed differential between the first input shaft 1002 and the second input shaft 1004. In FIG. 11, a perspective view shows the gearbox 1000 of FIG. 10 integrated into a linear actuator 1100 according to an example embodiment. First and second motors 1102, 1104 are coupled to the respective first and second input shafts of the gearbox 1000. A linear drive member 1106 is coupled to the output shaft of the gearbox 1000.

In the embodiments described above, the gearbox reduces the speed of both input shafts, and the reduction ratio of the first input shaft is smaller than that of the second input shaft. In other embodiments, a first input shaft coupled to a sun gear of a planetary gearset may have a reduction ratio that is larger than a second input tied to a ring gear of the planetary gearset. This may achieved, for example, by placing additional reduction gears between the first input shaft and the sun gear. In this embodiment, a secondary coupling path may be used to prevent the first input shaft from back-driving the second input shaft. This is the opposite of the embodiment shown above, although the implementation of the secondary coupling path may be similar. In this other embodiment, an override clutch would be configured to engage when the second input shaft stops or slows compared to the first input shaft.

In other embodiments, the gearbox may be an overdrive gearbox that increases the speed of one or more of the inputs at the output. In such a case, one of the input shafts may have a higher mechanical advantage than the other, and a secondary coupling path can be used to prevent back-driving between the input shafts. It will be understood that any of these gearbox embodiments may use alternate mechanisms than those shown herein to achieve similar results. For example, a secondary coupling path may use alternate coupling means instead of or in addition to the illustrated gears. These alternate coupling means may include pulleys, belts, chains, etc. In other embodiments, different engagement means may be used besides an override clutch. For example, a one-way clutch may be used in place of or in addition to the override clutch 124. In such a case, the one-way clutch engages if the first shaft 102 starts turning backwards relative to the second shaft 104.

While the illustrated gearbox is shown and described using input and output shafts, any input or output means may be used to couple rotational power into and out of the gearbox. These input and/or output means may include plates, flanges, pulleys, flexible joints, gears, splined hole, etc. Similarly, while the illustrated planetary gearset and other gears are shown as spur gears, other gearing means may be used such as helical gears, bevel gears, screw gears, etc.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

What is claimed is:

1. A gearbox comprising:
a planetary gearset;
a first input shaft coupled to a sun gear of the planetary gearset;
a second input shaft coupled to a ring gear of the planetary gearset;
an output shaft coupled to planet gears of the planetary gearset via a carrier; and
a second coupling path between the first input shaft and the second input shaft that is separate from the planetary gearset, the second coupling path comprising a clutch that engages and disengages in response to a speed differential between the first input shaft and the second input shaft.

2. The gearbox of claim 1, wherein the clutch comprises an override clutch.

3. The gearbox of claim 1, wherein engagement of the clutch prevents back driving between the first and second input shafts.

4. The gearbox of claim 3, wherein the engagement of the clutch prevents a second driving element coupled to the second input shaft from back driving a first driving element coupled to the first input shaft.

5. The gearbox of claim 3, wherein the engagement of the clutch prevents a first driving element coupled to the first input shaft from back driving a second driving element coupled to the second input shaft.

6. The gearbox of claim 1, wherein the planetary gearset provides a first reduction ratio of N:1 between the first input shaft and the output shaft and a second reduction ratio of M:1 between the second input shaft and the output shaft, wherein M>N.

7. The gearbox of claim 6, wherein the second coupling path provides a gear ratio of N1:N2 between the first input shaft and the second input shaft, wherein N1≈N2.

8. The gearbox of claim 6, wherein the override clutch engages if the first shaft is rotating slower than the second shaft.

9. The gearbox of claim 6, wherein the override clutch engages when a first motor driving the first shaft is stopped and a second motor driving the second shaft is running.

10. A linear actuator comprising:
first and second motors coupled to the respective first and second input shafts of the gearbox of claim 1; and
a linear drive member coupled to the output shaft of the gearbox of claim 1.

11. A method comprising:
providing a moment to one of a first input shaft and second input shaft of a gearbox;
coupling the first and second input shafts to an output shaft of the gearbox via a planetary gearset; and
in response to back-driving between the first and second input shafts, engage a secondary coupling path between the first input shaft and the second input shaft, the secondary coupling path separate from the planetary gearset.

12. The method of claim 11, further comprising detecting a speed differential between the first and second shafts, and wherein the engagement of the secondary coupling path occurs in response to a speed differential between the first input shaft and the second input shaft.

13. The method of claim 12, wherein the secondary coupling path is engaged via an override clutch that engages and disengages in response to the speed differential.

14. The method of claim 11, wherein coupling the first and second shafts to the output shaft via the planetary gearset comprises:
coupling the first input shaft to a sun gear of the planetary gearset;
coupling the second input shaft to a ring gear of the planetary gearset; and
coupling the output shaft to planet gears of the planetary gearset via a carrier.

15. The method of claim 11, wherein providing a moment to one of a first input shaft and second input shaft to the first and second input shafts comprise driving one of the first and second input shafts while the other is not driven.

16. The method of claim 11, wherein providing the moment to the first input shaft results in a high-speed, low-torque movement of the output shaft, and wherein providing the moment to the second input shaft results in a comparatively low-speed, high-torque movement of the output shaft.

17. The method of claim 11, further comprising coupling the output shaft of the gearbox to a linear drive member, the first and second moments causing actuation of the linear drive member.

18. The method of claim 11, wherein the secondary coupling path provides an approximate 1:1 ratio between the first and second input shafts.

19. A gearbox comprising:
a planetary gearset;
first input means coupled to a sun gear of the planetary gearset;
second input means coupled to a ring gear of the planetary gearset;
output means coupled to planet gears of the planetary gearset; and
a secondary coupling means engaging and disengaging the first input means and the second input means in response to a speed differential between the first input means and the second input means.

20. A linear actuator comprising:
first and second driving means coupled to the respective first and second input means of the gearbox of claim 18; and
linear actuation means coupled to the output means of the gearbox of claim 19.
